(19) United States
(12) Patent Application Publication
(10) Pub. No.: US 2014/0181851 A1
(43) Pub. Date: Jun. 26, 2014

(54) Methods Circuits Apparatuses Systems and Associated Computer Executable Code for Providing Viewer Analytics Relating to Broadcast and Otherwise Distributed Content

(71) Applicants: Dor Givon, Tel Aviv (IL); Gil Davidman, Herzliya (IL); Michal Lodzki, Ramat Hasharon (IL); Vladimir Sherman, Herzeliya (IL)

(72) Inventors: Dor Givon, Tel Aviv (IL); Gil Davidman, Herzliya (IL); Michal Lodzki, Ramat Hasharon (IL); Vladimir Sherman, Herzeliya (IL)

(21) Appl. No.: 13/892,282

(22) Filed: May 12, 2013

Related U.S. Application Data
(60) Provisional application No. 61/745,228, filed on Dec. 21, 2012.

(51) Int. Cl. H04N 21/258

(52) U.S. Cl. CPC H04N 21/25891
USPC 725/16

(57) ABSTRACT

There is provided according to some embodiments of the present invention methods, circuits, apparatuses, systems and associated computer executable code for providing viewer analytics relating to broadcast or otherwise distributed content.

### FIELD OF THE INVENTION

This application relates generally to the field of multimedia digital communication and viewer analytics. More specifically, the present invention relates to methods, circuits, apparatuses, systems and associated computer executable code for providing viewer analytics relating to broadcast and otherwise distributed content.

### BACKGROUND

Nielsen ratings are the audience measurement systems developed by the Nielsen Company, in an effort to determine the audience size and composition of television programming in the United States. Nielsen Media Research was founded by Arthur Nielsen, who was a market analyst whose career had begun in the 1920s with brand advertising analysis and expanded into radio market analysis during the 1930s, culminating in Nielsen ratings of radio programming, which was meant to provide statistics as to the markets of radio shows. In 1950, Nielsen moved to television, developing a ratings system using the methods he and his company had developed for radio. That method has since become the primary source of audience measurement information in the television industry around the world.

The most commonly cited Nielsen results are reported in two measurements: ratings points and share, usually reported as: “ratings points/share”. As of Aug. 27, 2012, there are an estimated 114.2 million television households in the United States, a drop of nearly 500,000 from the previous year. A single national ratings point represents one percent of the total number, or 114,200,000 households for the 2012-13 season. Nielsen re-estimates the number of TV-equipped households each August for the upcoming television season. Share is the percentage of television sets in use tuned to the program. For example, Nielsen may report a show as receiving a 9.2/15 during its broadcast, meaning that on average 9.2 percent of all television-equipped households were tuned in to that program at any given moment, while 15 percent of households watching TV were tuned into that program during this time slot. The difference between rating and share is that a rating reflects the percentage of the total population of televisions tuned to a particular program while share reflects the percentage of televisions actually in use.

There are some issues regarding accuracy and potential bias within Nielsen's rating system, including some concerns that the Nielsen ratings system is rapidly becoming outdated due to new technology like smartphones, DVRs, tablet computers, and Internet viewing. In June 2006, however, Nielsen announced a plan to revamp its entire methodology to include all types of media viewing in its sample.

Since viewers are aware of being part of the Nielsen sample, it can lead to response bias in recording and viewing habits. Audience counts gathered by the self-reporting diary methodology are sometimes higher than those gathered by the electronic meters which eliminate any response bias. This trend seems to be more common for news programming and popular prime time programming. Also, daytime viewing and late night viewing tend to be under-reported by the diary.

Another issue with the measuring system itself is that it fails the most important criterion of a sample: it is not random in the statistical sense of the word. A small fraction of the population is selected and only those that actually accept are used as the sample size. In many local areas of the 1990s, the difference between a rating that kept a show on the air and one that would cancel it was so small as to be statistically insignificant, and yet the show that just happened to get the higher rating would survive. And yet in 2009 of the 114,500,000 U.S. television households only 25,000 total American households (0.02183% of the total) participated in the Nielsen daily metered system. In addition, the Nielsen ratings encouraged a strong push for demographic measurements. This caused problems with multiple TV households or households where viewers would enter the simpler codes (usually their child's) raising serious questions to the quality of the demographic data. The situation further deteriorated as the popularity of cable TV expanded the number of viewable networks to the point that the margin of error has increased due to the sampling sizes being too small. Compounding matters is the fact that of the sample data that is collected, advertisers will not pay for time shifted (recorded for replay at a different time) programs, rendering the ‘raw’ numbers useless.

A related criticism of the Nielsen ratings system is its lack of a system for measuring television audiences in environments outside the home, such as college dormitories, transport terminals, bars, jails, and other public places where television is frequently viewed, often by large numbers of people in a common setting. In 2005, Nielsen announced plans to incorporate viewing by away-from-home college students into its sample. Internet TV viewing is another rapidly growing market for which Nielsen Ratings fail to account for viewer impact. Apple iTunes, atomfilms, Hulu, YouTube, and some of the networks' own websites (e.g., ABC.com, CBS.com) provide full-length web-based programming, either subscription-based or ad-supported. Though web sites can already track popularity of a site and the referring page, they can't track viewer demographics. To both track this and expand their market research offerings, Nielsen purchased NetRatings in 2007. However, noted in a February 2012 New York Times article the computer and mobile streams of a show are counted separately from the standard TV versions further degrading the overall quality of the sampling data. As a result there was no way for NBC to tell if there was any overlap between the roughly 111.3 million standard TV viewers and 2.1 million live stream viewers of the Super Bowl.

IPTV (Internet Protocol Television) is a system where a digital television service is delivered by using Internet Protocol over a network infrastructure, which may include delivery by a broadband connection. A general definition of IPTV is television content that, instead of being delivered through traditional broadcast and cable formats, is received by the viewer through the technologies used for computer networks.

For residential users, IPTV is often provided in conjunction with Video on Demand and may be bundled with Internet services such as Web access and Voice over IP (“VoIP”). The commercial bundling of IPTV, VoIP and Internet access is referred to as “Triple Play” service (adding mobility is called “Quadruple Play”). IPTV is typically supplied by a service provider using a closed network infrastructure. This closed network approach is in competition with the delivery of TV content over the public Internet, called Internet Television. In businesses, IPTV may be used to deliver television content over corporate LANs.

In 1994, ABC's World News Now was the first television show to be broadcast over the Internet, using the CU-SeeMe videoconferencing software. The term IPTV first appeared in 1995 with the founding of Precept Software by Judith Estrin and Bill Carrico. Precept designed and built an internet video product named “IP/TV”. IP/TV was an MBONE compatible Windows and Unix based application that moved single and multi-source audio/video traffic, ranging from low to DVD quality, using both unicast and IP multicast RTP/RTCP. The software was written primarily by Steve Casner, Karl Auerbach, and Cha Ghee Kuan. Precept was acquired by Cisco Systems in 1998. Cisco retains the “IP/TV” trademark.

Internet radio company AudioNet started the first continuous live webcasts with content from WFAA-TV in January, 1998 and KCTU-LP on Jan. 10, 1998. Kingston Communications, a regional telecommunications operator in UK, launched KIT (Kingston Interactive Television), an IPTV over DSL broadband interactive TV service in September 1999 after conducting various TV and VoD trials. The operator added additional VoD service in October 2001 with Yes TV, a provider of VoD content. Kingston was one of the first companies in the world to introduce IPTV and IP VOD over ADSL.

In 2006, AT&T launched its U-Verse IPTV service. Comprised of a national head-end and regional video serving offices, AT&T offered over 300 channels in 11 cities with more to be added in 2007 and beyond. While using IP protocols, AT&T has built a private IP network exclusively for video transport. IPTV uses a two-way digital broadcast signal sent through a switched telephone or cable network by way of a broadband connection and a set-top box programmed with software (much like a cable or DSS box) that can handle viewer requests to access to many available media sources.

IPTV covers both live TV (multicasting) as well as stored video (Video on Demand VOD). The playback of IPTV requires either a personal computer or a set-top box connected to a TV. Video content is typically compressed using either a MPEG-2 or a MPEG-4 codec and then sent in an MPEG transport stream delivered via IP Multicast in case of live TV or via IP Unicast in case of Video on Demand. IP Multicast is a method in which information can be sent to multiple computers at the same time. The newly released (MPEG-4) H.264 codec is increasingly used to replace the older MPEG-2 codec.

In standards-based IPTV systems, the primary underlying protocols used for Live TV is using IGMP version 2 for connecting to a multicast stream (TV channel) and for changing from one multicast stream to another multicast stream (TV channel change). Video on Demand (“VOD”) generally use the Real Time Streaming Protocol (RTSP). Currently, the only alternatives to IPTV are traditional TV distribution technologies such as terrestrial, satellite and cable. However, cable can be upgraded to two-way capability and can thus also carry IPTV.

Network Personal Video Recording is a consumer service where real-time broadcast television is captured in the network on a server allowing the end user to access the recorded programs on the schedule of their choice, rather than being tied to the broadcast schedule. The NPVR system provides time-shifted viewing of broadcast programs, allowing subscribers to record and watch programs at their convenience, without the requirement of a truly personal PVR device.

The IP-based video distribution platform offers significant advantages over traditional distribution platform, including the ability to integrate television with other IP-based services like high speed Internet access and VoIP. A switched IP network also allows for the delivery of significantly more content and functionality. In a typical TV or satellite network, using broadcast video technology, all the content constantly flows downstream to each customer, and the customer switches the content at the set-top box. The customer can select from as many choices as the telecomms, cable or satellite company can stuff into the “pipe” flowing into the home. A switched IP network works differently. Content remains in the network, and only the content the customer selects is sent into the customer's home. That frees up bandwidth, and the customer's choice is less restricted by the size of the “pipe” into the home.

Most video enters the system at the telco's national head-end, where network feeds are pulled from satellites and encoded if necessary (often in MPEG-2, though H.264 and Windows Media are also possibilities). The video stream is broken up into IP packets and dumped into the telco's core network, which is a massive IP network that handles all sorts of other traffic (data, voice, etc.) in addition to the video. The video streams are received by a local office, which is adapted to deliver the video streams to the end users. (i.e. subscriber media presentation appliances). The local office may add local content (such as local TV stations, advertising, and video on demand) to the received video streams. The local office is also adapted to house and operate the IPTV middleware. The middleware software stack handles user authentication, billing, channel change requests, VoD requests, and “last mile” distribution/routing/switching of the content bearing data streams.

A smart TV, sometimes referred to as connected TV or hybrid TV, (not to be confused with IPTV, Internet TV, or with Web TV), describes a trend of integration of the Internet and Web 2.0 features into television sets and set-top boxes, as well as the technological convergence between computers and these television sets/set-top boxes. The devices have a higher focus on online interactive media, Internet TV, over-the-top content, as well as on-demand streaming media, and less focus on traditional broadcast media than traditional television sets and set-top boxes. Similar to how the Internet, Web widgets, and software applications are integrated in modern smartphones, the name “smart TV” is akin to “smart phone”.

The technology that enables smart TVs is also incorporated in devices such as set-top boxes, Blu-ray players, game consoles, hotel television systems, and other devices. These devices allow viewers to search and find videos, movies, photos and other content on the Web, on a local cable TV channel, on a satellite TV channel, or on a local storage drive.

A smart TV device is either a television set with integrated Internet capabilities or a set-top box for television that offers more advanced computing ability and connectivity than a contemporary basic television set. Smart TVs may be thought of as an information appliance or the computer system from a handheld computer integrated within a television set unit, as such smart TV often allows the user to install and run more advanced applications or plugins/add-ons based on a specific platform. Smart TVs run complete operating system or mobile operating system software providing a platform for application developers.

Smart TV platforms or middleware have a public Software development kit (SDK) and/or Native development kit (NDK) for apps so that third-party developers can develop applications for it, and an app store so that the end-users can install and uninstall apps themselves. The public SDK enables third-party companies and other interactive application developers to “write” applications once and see them run successfully on any device that supports the smart TV platform or middleware architecture which it was written for, no matter who the hardware manufacturer is.

“Smart TV”s: (1) Deliver content from other computers or network attached storage devices on a network like photos, movies and music using either a Digital Living Network Alliance/Universal Plug and Play media server or similar service program like Windows Media Player or Network-attached storage (NAS), or via iTunes; and (2) Provide access to Internet-based services including traditional broadcast TV channels, catch-up services, video-on-demand, Electronic program guide, interactive advertising, personalization, voting, games, social networking, and other multimedia applications.

The concept of smart TVs is still evolving, with both proprietary and open source software frameworks being commercially promoted. Some have the ability to run applications (sometimes available via an ‘app store’ digital distribution platform), interactive on-demand media, personalized communications, and social networking features.

With channels of distribution and variety of presentation platforms ever increasing, metering of content viewership and tracking audience response to content is likewise an ever increasing challenge. There is need in the field for improved methods and technologies for assessing content viewership and responses to content distributed across a broad range of platforms and geographies.

### SUMMARY OF INVENTION

The present invention includes methods, circuits, apparatuses, systems and associated computer executable code for providing viewer analytics relating to broadcast and otherwise distributed content. According to some embodiments, there may be provided a system for assessing one or more content specific audience characteristics or parameters, wherein the system may include a computer server including one or more data storage units and network communication circuitry adapted to receive and store content specific viewing parameters from each of a set of mobile communication devices. The system may also include at least one mobile communication device adapted to: (1) acquire one or more characterization parameters relating to: (a) content being presented on one or more presentation devices located in proximity to said at least one mobile communication device, (b) presentation environment, and (c) persons present in proximity to said at least one mobile communication device; and (2) transmit acquired parameters to said server. According to some embodiments, the at least one mobile device may be a smartphone, a tablet computing device, an internet connected watch (e.g. iWatch) or another other computing and communication enabled device known today or to be devised in the future.

According to some embodiments, characterization parameters relating to content being presented may include one or more parameters from the group: (1) a content identifier, (2) a time of content presentation, (3) duration of content presentation, (4) number of content presentation devices, (5) a content presentation device characteristic, and (6) an estimated location of content presentation.

According to further embodiments, characterization parameters relating to presentation environment may include one or more from the group: (1) background noise conditions, (2) background lighting conditions, and (3) venue type.

According to yet further embodiments, characterization parameters relating to persons present in proximity to said at least one mobile communication device may include one or more from the group: (1) estimated number of persons, (2) activity of one or more persons, (3) demographic of one or more persons, and (4) emotional state of one or more persons.

According to some embodiments, there may be provided a system which may: (1) perform analytics on data received from or near one or more displays presenting/displaying content, and (2) generate statistics and/or reports and/or maps relating to broadcast content audience characteristics. Broadcast content audience characteristics or parameters may include: (1) total number of viewers; (2) average number of viewers per display; (3) viewer demographics; (4) viewer geographic distribution; (5) viewer demographics per geographic region; (6) viewer attention level; (7) viewer attention level across portions of the broadcast content, and optionally segmented by geographic region and/or demographics; (8) viewer emotional states across portions of the broadcast content, and optionally segmented by geographic region and/or demographics; (9) viewer behavior (e.g. sitting, standing, jumping, moving around, flipping channels, etc.) across portions of the broadcast content, and optionally segmented by geographic region and/or demographics; (10) viewer consumption behavior (e.g. eating food, drinking, etc.) across portions of the broadcast content, and optionally segmented by geographic region and/or demographics; and/or (11) any combination of the above listed characteristics. According to further embodiments, the system may provide substantially real-time data relating to current audience activity, behavior, mental state, temperament, or the like, segmented by any one or any combination of the above listed audience characteristics or parameters, for example for purposes of: (1) dynamic ad selection and/or insertion into primary content; (2) primary content assessment for pricing of ads inserted in the content; (3) ad value assessment, (4) primary content assessment for subsequent audience targeting, such as ad targeting; and/or (5) providing an audience interface for interactive content such as game shows.

Embodiments of the present invention are applicable to all forms of media distribution according to any means known today or to be devised in the future. Various embodiments may be applied to conventional broadcast television, cable television, satellite television, IP TV, Over the Top (“OTT”) Content and Digital Living Network Appliances (“DLNA”).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an exemplary architecture of a network based on a system according to embodiments of the present invention; and

FIG. 2 shows a functional block diagram including display side and server side components of a system according to embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes methods, circuits, apparatuses, systems and associated computer executable code for providing viewer analytics in connection with broadcast or otherwise distributed content, including both primary content and advertising content. The term broadcast content is intended to cover live broadcast content, pre-recorded broadcast content, web-cast content, pod-cast content, video-on-demand, internet streaming, internet accessible video content (e.g. YouTube, Netflix, etc.), MultiScreen Services (e.g. Netflix or U-verse provided on home display and through application running on mobile communication device or computer). The term viewer analytics is intended to cover information relating to the viewing of specific broadcast content, including but not limited to: viewer total count, viewer count per location/display, viewer geographic distribution, viewer demographics, viewer behavior during viewing and various combinations thereof.

According to some embodiments, there may be provided a system which may: (1) perform analytics on data received from or near one or more displays presenting/displaying content, and (2) generate statistics and/or reports and/or maps relating to broadcast content audience characteristics. Broadcast content audience characteristics may include: (1) total number of viewers; (2) average number of viewers per display; (3) viewer demographics; (4) viewer geographic distribution; (5) viewer demographics per geographic region; (6) viewer attention level; (7) viewer attention level across portions of the broadcast content, and optionally segmented by geographic region and/or demographics; (8) viewer emotional states across portions of the broadcast content, and optionally segmented by geographic region and/or demographics; (9) viewer behavior (e.g. sitting, standing, jumping, moving around, flipping channels, etc.) across portions of the broadcast content, and optionally segmented by geographic region and/or demographics; (10) viewer consumption behavior (e.g. eating food, drinking, etc.) across portions of the broadcast content, and optionally segmented by geographic region and/or demographics; (11) viewer or viewers numbers and/or behavior per display, platform or screen; and/or (12) any combination of the above listed characteristics. According to further embodiments, the system may provide substantially real-time data relating to current audience activity, segmented by any one or any combination of the above listed audience characteristics or parameters, for example for purposes of: (1) dynamic ad selection and/or insertion into primary content, (2) primary content assessment for pricing of ads inserted in the content, (3) ad value assessment, and/or (4) primary content assessment for subsequent audience targeting, such as ad targeting.

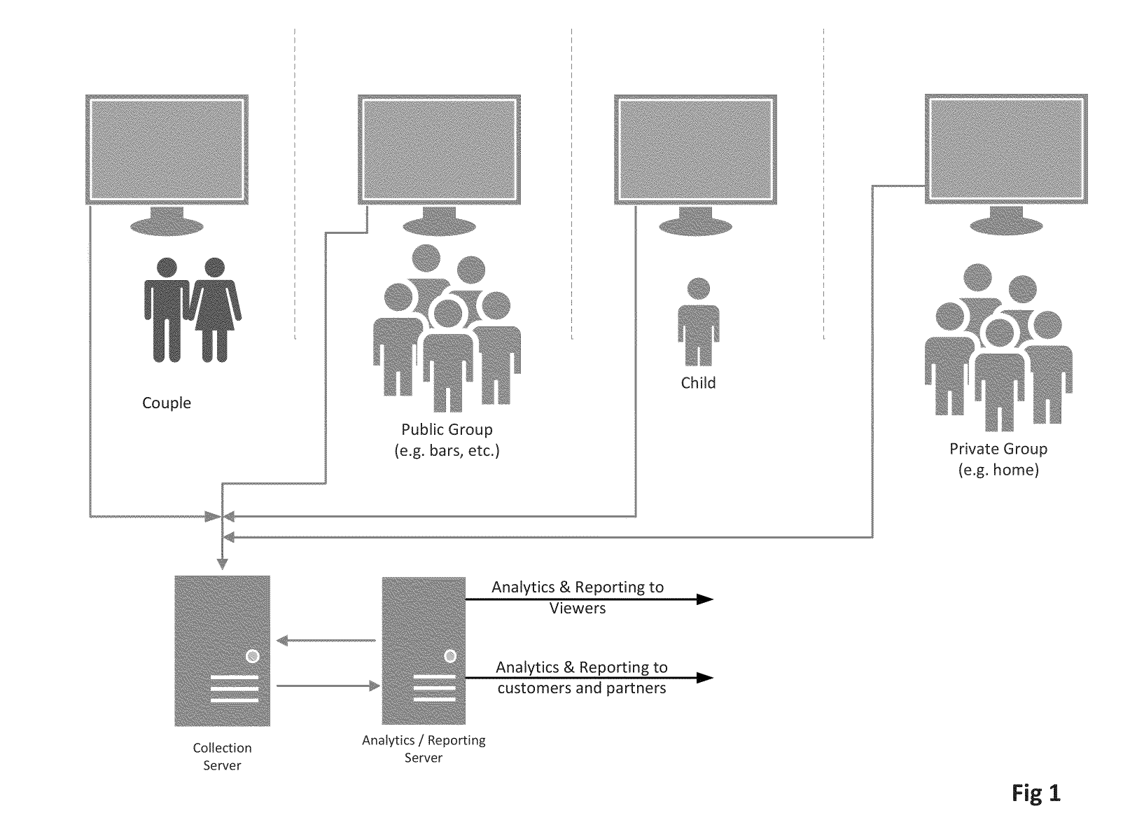

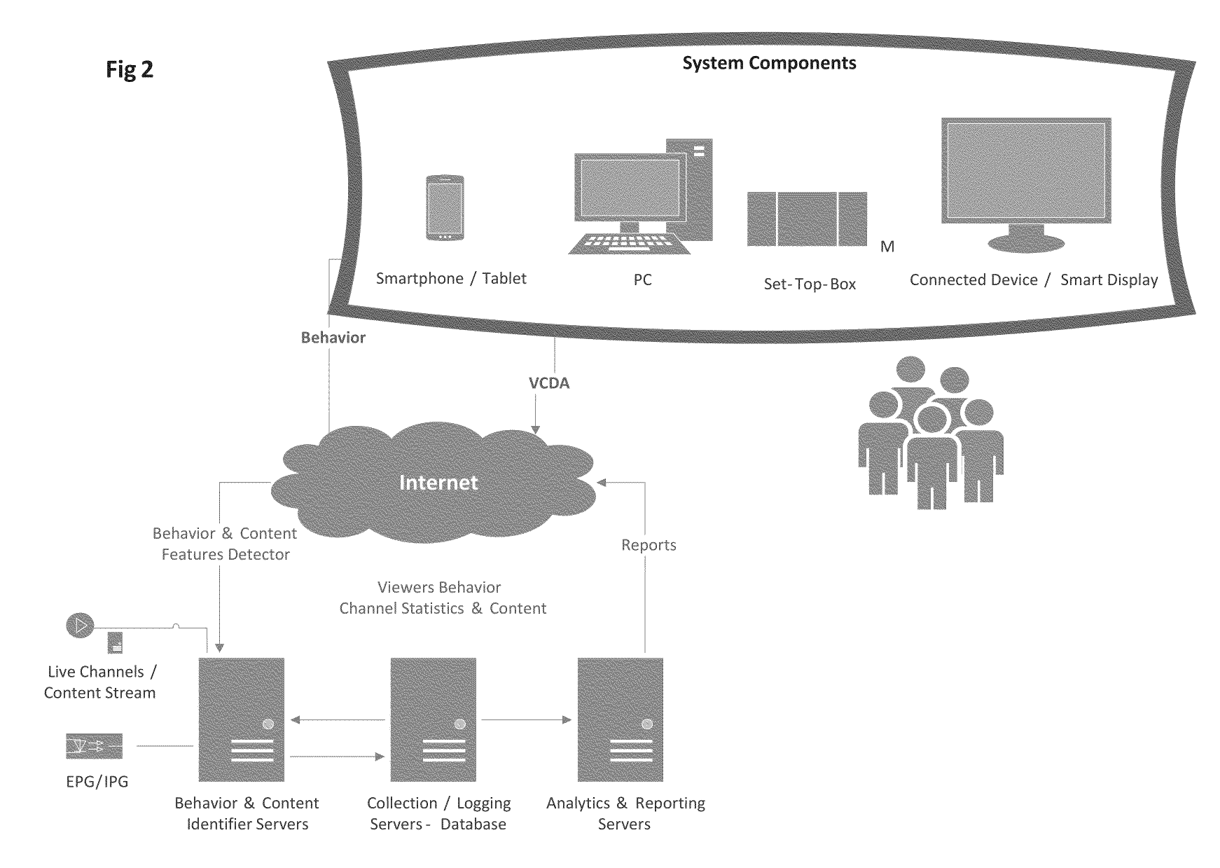

Turning now to FIG. 1, there is shown an exemplary architecture of a network based on a system according to embodiments. FIG. 2 shows a functional block diagram including display side and server side components of a system according to embodiments. Systems according to some embodiments may include a viewer monitoring application running on a display, on a functionally associated appliance, and/or on a mobile communication device such as a smartphone. The viewer monitoring application may be adapted for viewer presence detection, viewer activity monitoring and/or self-localization. According to further embodiments, the monitoring application may have access to a camera functionally associated with a display and may include video analytics modules adapted to: (1) identify presence of individuals in-front of the display, (2) characterize (e.g. demographically, gender, age, etc.) identified individuals, (3) recognize facial gestures and correlate facial gestures to emotional states, (4) detect activity of persons present in-front of the display, and (5) identify brands of items present on one or more viewers (e.g. clothes, watch, etc.) or located somewhere in the field of view of the camera.

According to further embodiments, the viewer monitoring application running on a display, on a functionally associated appliance and/or on a mobile communication device may have access to a microphone and may include audio analytic capabilities adapted to estimate a number of viewers present or in proximity to the display, and optionally to assess a level of focus/attention being given to the presented content. According to yet further embodiments, the viewer monitoring application may include audio analytic capabilities adapted to estimate relative locations of viewers (e.g. triangulation) in proximity with a display.

According to further embodiments, the viewer monitoring application running on a display, on a functionally associated appliance and/or on a mobile communication device may have access to RF communication circuits (e.g. Wi-Fi/Bluetooth) and may include RF signal analytic capabilities adapted to estimate a number of viewers with mobile communication devices present or in proximity to the display, and optionally to assess a level of focus/attention being given to the presented content. According to yet further embodiments, the viewer monitoring application may include RF signal analytic capabilities adapted to estimate relative locations of viewers with mobile communication devices (e.g. triangulation) in proximity with a display.

A system according to embodiments may also include a Presented Content Identification Application (PCIA) adapted to detect which primary content and which advertising content is being displayed/presented at a given display during a given period of time. According to some embodiments, the PCIA may detect or identify specific features of one or more video frames and/or one or more audio segments being presented on a specific display and may correlate detected/identified features with a specific identity of the content being presented, for example using a reference database having records matching features to content identifiers (e.g. searchable image database, video and/or audio watermark databases, etc.). According to some embodiments, detected features may include: (1) video watermarks, (2) audio watermarks, (3) extracted image features, (4) extracted audio features, (5) EPG, IPG or other broadcaster provided signaling through any other API, and (5) any other identifiable features known today or to be devised in the futures.

According to some embodiments, the system may include a controller, or control application/module and a communication module adapted to receive information from the Viewer Monitoring Application and/or from the PCIA, and to convey the received information to one or more external servers, for example one or more collection servers and/or one or more content identifying servers and/or one or more viewer behavior identifier servers. According to further embodiments, viewer presence, behavior, emotional state and all other viewer characteristics may be assessed or estimated by the viewer monitoring application, and only data indicating assessed/estimated parameters may be forwarded to the servers through the communication modules.

The collection server(s) may receive, store and optionally process information about presented content and detected corresponding audience characteristics for one or more displays functionally associated with a system according to embodiments. The communication module may also provide bidirectional communication between the PCIA and a remote database including records correlating detected feature to content identifiers, which content identifiers indicate which specific content is being presented on the display from which the features were extracted. The communication module may be a wired or wireless module and may be adapted to communicate data unidirectionally or bidirectionally according to any communication protocols known today or to be devised in the future. According to some embodiments, the communication module may communicate with one or more external servers through a proxy server or gateway. According to some embodiments, there may be provided a device to device communication capability usable to transfer data between devices (e.g. mobile to TV and TV to tablet), for example using protocols such as TCP/IP and/or DNLA. According to further embodiments, there may be provided a cache for storing information relating to presented content and detected corresponding audience characteristics and/or behavior, for example when a data connection to the servers is not available.

According to some embodiments, the monitoring application and/or the PCIA may be installed and/or run on a processor functionally associated with a video display, for example a processor of a smart TV and/or a processor of a set-top box and/or a processor of a computing platform (e.g. computer) configured to act as a video signal source for a video display. According to further embodiments, either the viewer monitoring application and/or the PCIA and/or the communication module may reside and run on a mobile communication device such as a smartphone. According to embodiments associated with mobile communication devices, identification of content being presented in the vicinity of the mobile communication device can be ascertained using the microphone and/or the video camera of the mobile communication device. Additionally, audio information received by the microphone of the mobile communication device may be used to estimate a position of the device and thus the viewer relative to a display. Accelerometers on the mobile communication device may provide information indicative of movements and thus behavior of a viewer while carrying the device in the vicinity of a display presenting identified content.

According to some embodiments, at least portions of the viewer monitoring application and/or the PCIA may reside in the digital memory of the mobile communication device and may run on a processor of the mobile communication device. The PCIA may access a microphone of the communication device and monitor for content related audio features such as audio watermarks. The PCIA may also access a video camera of the communication device and may monitor for content related video features such as visual watermarks or other visually identifiable characteristics. As with previous embodiments, detected features may be referenced in a database to identify the content associated with the detected feature(s).

According to a further embodiment, a viewer monitoring application running on a mobile communication device, personal computer and/or tablet computer may monitor and detect a viewer's behavior by monitoring various sensors and circuits associated with the mobile communication device, personal computer and/or tablet computer. The monitoring application may ascertain viewer movements by accessing accelerometers and/or GPS circuits of the communication device. The monitoring application may also ascertain or estimate a viewer's attention/focus level to presented content by monitoring whether the viewer is using any of the functionality of the communication device, personal computer and/or tablet computer (e.g. phone, web browsing, etc.) during presentation of one or more content segments.

According to further embodiments, a mobile communication device's data modem(s) may be used as a mean to convey viewer monitoring and content identification information to collection servers according to embodiments.

According to further embodiments, either the PCIA and/or a viewer monitoring application running on a mobile communication device may utilize one or more wireless communication circuits of the mobile communication device to access information stored on displays, computers and/or set-top boxes in proximity. The PCIA and/or viewer monitoring application running on mobile communication device may wirelessly access and utilize one or more data storage and/or data acquisition circuits of displays, computers and/or set-top boxes in proximity. For example, the viewer monitoring application on the mobile communication device may wirelessly access a forward looking camera and/or a microphone of a display in proximity, while a PCIA may wirelessly access current and historic channel information from a receiver associated circuit of a set-top box and/or a display. The PCIA may also wirelessly access viewing history from a content viewing application running on a computer in proximity. The above described wireless accessing may be achieved by utilizing native Application Interfaces (API's) on the target devices whose information and/or resources are being accessed by the PCIA and/or viewer monitoring application.

According to further embodiments, a monitoring application may access the communication device's microphone and may monitor for audio energy levels emitted from the left and right speakers of the display. Left and right audio channels of the display may be audio watermarked or otherwise distinguished, and the monitoring application may be adapted to use measured relative energy levels to estimate the communication devices position and/or angle relative to the display. According to embodiments, a mobile device application will have grant to additional mobile device permission such as: GPS, user name, activity (phone, SMS, accelerometer). Optionally, the application will also have user approval required to access/operate user mobile software functionality, such as TV synced content.

According to further embodiments, the monitoring application may assess an activity and/or a behavior (both of which terms are used interchangeably) of one or more viewers and/or users in proximity of a content presentation device. The application may collect data from accelerometers of a functionally associated mobile communication device, assess movement of a carrier of the communication device, and thereby derive or estimate a behavior or activity of the carrier. The application may access video data from a functionally associated camera, on a mobile device and/or presentation device, and may analyze the data to track movement of individuals in proximity, thereby deriving or estimating a behavior or activity of one or more persons in proximity of the presentation device during specific content presentation. The application may access audio data from a functionally associated microphone, of a mobile communication device and/or presentation device, and may analyze the audio data to estimate movements or sentiment of individuals in proximity, thereby deriving or estimating a behavior or activity of one or more persons in proximity of the presentation device during specific content presentation. It should be understood that any and all accelerometer data, video data and audio data analytics algorithms, known today or to be devised in the future, are applicable to various aspects of the present invention.

Viewer data provided by a plurality of applications installed on a plurality of display related devices and plurality of mobile communication devices, located across broad geographic region, may be aggregated on one or more collection servers operating according to embodiments of the present invention. Data collected on these collection servers may be analyzed and used to provide: (1) crowd watching information/maps/reports associated with specific content at specific times, including ads, broadcasts; (2) mass behavior information/maps/reports during specific broadcast of specific content, including ads, at specific times; (3) mass viewing or behavior information/maps/reports associated with specific content, including ads, downloaded and/or ordered at arbitrary times.

Any audience related (e.g. acceptance, behavior, preference, etc.) reports known today or to be devised in the future may be generated, optionally in real-time, in text or graphic form based on the information received and stored in the collection server(s).

According to further embodiments, applications running on a display and/or viewer mobile communication device may present a user/viewer various reports or maps indicting which content, programs and/or channels are being viewed in his vicinity or within a user selected region. Additional value added information or services may be provided through the viewer side applications, including viewing recommendations, discount offers and/or offers for free content and/or other free presents.

According to further embodiments, analytics and/or reporting servers may provide a social viewing guide, which social viewing guide (Social EPG) may include viewer feedback information from other viewers a user's proximity and/or from other viewers located in any region designated by the user. According to further embodiments, there may be provided parental control filters which may use or be based on the feedback and/or information provided by other users on the Social EPG. According to yet further embodiments, one or more reporting servers may access data on the collection servers to provide a user with a report of personal viewing history.

It should be clear to one of skill in the art that any novel feature, or combination of features, shown as part of any of the above described embodiments may be applicable to another one of the described embodiments. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A system for assessing one or more content specific audience parameters, said system comprising:
a computer server including one or more data storage units and network communication circuitry adapted to receive and store content specific viewing parameters from each of a set of mobile communication devices; and
at least one mobile communication device adapted to: (1) acquire one or more characterization parameters relating to: (a) content being presented on one or more presentation devices located in proximity to said at least one mobile communication device, (b) presentation environment, and (c) persons present in proximity to said at least one mobile communication device; and (2) transmit acquired parameters to said server.

2. The system according to claim 1, wherein characterization parameters relating to content being presented include one or more parameters from the group: (1) a content identifier, (2) a time of content presentation, (3) duration of content presentation, (4) number of content presentation devices, (5) a content presentation device characteristic, and (6) an estimated location of content presentation.

3. The system according to claim 1, wherein characterization parameters relating to presentation environment include one or more from the group: (1) background noise conditions, (2) background lighting conditions, and (3) venue type.

4. The system according to claim 1, wherein characterization parameters relating to persons present in proximity to said at least one mobile communication device include one or more from the group: (1) estimated number of persons, (2) activity of one or more persons, (3) demographic of one or more persons, (4) behavior of one or more persons, (5) emotional state of one or more persons, (6) identity of at least one person using the system, and (7) identity of at least one person in proximity to said at least one mobile communication device.

5. The system according to claim 1, wherein said at least one mobile communication device is further adapted to determine an identifier of one or more presentation devices or platforms in proximity.

6. The system according to claim 1, wherein said at least one mobile communication device is further adapted to determine an identifier of one or more mobile communication devices used by audience members in proximity.
